(19) United States
(12) Patent Application Publication
(10) Pub. No.: US 2012/0268338 A1
(43) Pub. Date: Oct. 25, 2012

(54) CONDUCTING POLYMER ANTENNA

(76) Inventors: Seunghyup Yoo, Daejon (KR); Gregory D. Durgin, Atlanta, GA (US); Bernard Kippelen, Decatur, GA (US); Warren N. Herman, Laurel, MD (US)

(21) Appl. No.: 11/861,076

(22) Filed: Sep. 25, 2007

Related U.S. Application Data
(60) Provisional application No. 60/826,858, filed on Sep. 25, 2006.

(51) Int. Cl. H01Q 1/38; B05D 5/12; H01Q 9/26

(52) U.S. Cl. 343/803; 343/700 MS; 427/58

(57) ABSTRACT

An apparatus for receiving and transmitting electromagnetic signals. In one aspect, the apparatus is an antenna. The antenna comprises a dielectric substrate and a non-metallic conducting layer substantially overlying the substrate. In one aspect, the non-metallic conducting layer is an intrinsic conducting polymer (“ICP”). In one exemplary method of manufacturing the antenna, the desired outline of the antenna may be first printed out on a substantially flexible substrate. In one example, a substrate made from polyethylene terephthalate may be used.

This invention was made with government support under Contract number H98230-04-C-0495 awarded by the Maryland Procurement Office. The United States government has certain rights in the invention.

### FIELD OF THE INVENTION

The field of this invention relates generally to antennas, and more particularly to a folded dipole antenna.

### BACKGROUND OF THE INVENTION

Radio frequency (RF) systems enable contactless transfer of data between RF tags and a reader placed at a distance from the tags. This contactless data transfer technology is used in a multitude of applications for the location and/or identification of static or mobile objects. Due to a large range, that can be of several meters, and due to the amount of data that can be transmitted, RF systems are increasingly preferred over other identification systems, such as barcode systems. Since many applications involve transmitting identification data, these RF systems are often referred to as RFID technologies, and the RF tags referred to as RFID tags.

The major differentiation criteria for RFID tags are the operating frequency, the physical coupling method for the transfer of data between the tag and the reader, and the distance over which the information can be transferred efficiently between the tag and the reader. RFID systems are operated over a wide range of frequencies, ranging from the 125/134 KHz low frequency (LF) range to the 13.56 MHz high frequency (HF), to the 868/915 MHz ultra-high frequency (UHF), to the 2.45-5.8 GHz microwave range. The physical coupling can be electric, magnetic, or electromagnetic. The range can vary from millimeters to above 15 meters. RFID tags come in various sizes and form factors and have various costs. The cost usually scales with functionality, the amount of data that can be transferred, and range. Although RFID tags operating at HF (13.56 MHz) can be fabricated at low cost, their range is very limited, typically to less than a meter because near-field transfer of electric power between the reader the tag is inductive in nature. Many applications require operating ranges larger than one meter, preferably larger than 10 meters. RFID tags operating with electromagnetic waves in the ultra-high frequency band (UHF) and in the microwave range are, therefore, desirable because they allow for larger ranges.

An indispensable component in RFID tags and in other wireless devices that operate at UHF and microwave frequencies is the antenna. The antenna is the interface between the RFID tag and the propagation medium (e.g., air in most RF systems) and is, therefore, a deciding factor in the performance of an RF system. The principal properties of antennas are directivity, gain, and radiation resistance. Antennas that operate at UHF and microwave frequencies can be fabricated in multiple shapes and sizes. One possible design for an antenna operating in these ranges is a folded dipole antenna, but many variations from this design can be derived by somebody skilled in the art.

An important parameter of an antenna is the ohmic resistance and its relative magnitude to the radiation resistance of the antenna. The power transmitted to an antenna is always greater than the power that is radiated. The difference between the transmitted power and the radiated power is the power dissipated in the ohmic resistance of the antenna conducting trace and in other losses. Therefore, antennas are generally fabricated from conductors that have high conductivities, such as metals, to minimize the ohmic resistance and maintain high antenna efficiency. For instance, antennas are fabricated from sheets of Cu or Al that are laminated to a dielectric substrate, such as printed circuit boards (e.g. FR4), and patterned using lithographic techniques followed by metal etching. Metals such as Cu and Al have bulk conductivities of 5.9×10⁵ S/cm and 3.7×10⁵ S/cm, respectively. Due to the mechanical properties of the metal sheets and the substrates to which they are laminated, these antennas have limited flexibility, which limits the form factor of the RFID tag. Furthermore, the processing of these antennas requiring chemical etching is not cost efficient.

An alternative method for fabricating antennas for RFID tags operating in the UHF and microwave range is to use a composite material that contains electrically conducting particles, such as metal particles (Ni, Ag, Au, Ag, and the like), that can be incorporated into a polymer binder and processed into an antenna as described in U.S. Pat. No. 6,271,793 B1. An example of such a metal containing conducting polymer is Electrodag PF-050, sold by Acheson Colloids Company (Part Huron, Mich. 48060), which can be processed using screen printing. However, these inks are expensive because silver is a noble metal and they require a curing step at 140° C., which can damage the RFID tag's substrate. Furthermore, metal containing inks can be subject to corrosion in some environments and can be considered as water pollutants.

In view of the preceding, there is a need for antennas for RFID tags that operate in the UHF and microwave range that are low cost, do not require curing steps at high temperature, are compatible with light weight flexible substrates, do not contain any metal to prevent sensitivity to corrosion, and do not cause any harm to the environment.

### SUMMARY

The invention relates to an apparatus for receiving and transmitting electromagnetic signals. In one aspect, the apparatus is an antenna. However, it is contemplated that the apparatus may also comprise an RF isolator or other passive RF device. In another aspect, the apparatus is based on a common planar folded-dipole antenna.

In one embodiment, the antenna comprises a dielectric substrate and a non-metallic conducting layer substantially overlying the substrate. In one aspect, the non-metallic conducting layer can be an intrinsic conducting polymer (“ICP”). In another exemplary aspect, the antenna has a frequency of operation that is configured for about 915 MHz, which is one of the carrier frequencies for long-range (greater than about 1 m) commercial RFID tags.

In one exemplary method of manufacturing the antenna, the desired outline of the antenna may be first printed out on a substantially flexible substrate. In one example, a substrate made from polyethylene terephthalate may be used. However, other materials may be used for the substrate, including, but not limited to polyesters, polycarbonates, poly(methyl methacrylate)s, poly(styrene)s, polyolefins, polyimides, fluoropolymers, polysulfones, and the like.

### DETAILED DESCRIPTION OF THE FIGURES

These and other features of the preferred embodiments of the invention will become more apparent in the detailed description in which reference is made to the appended drawings wherein:

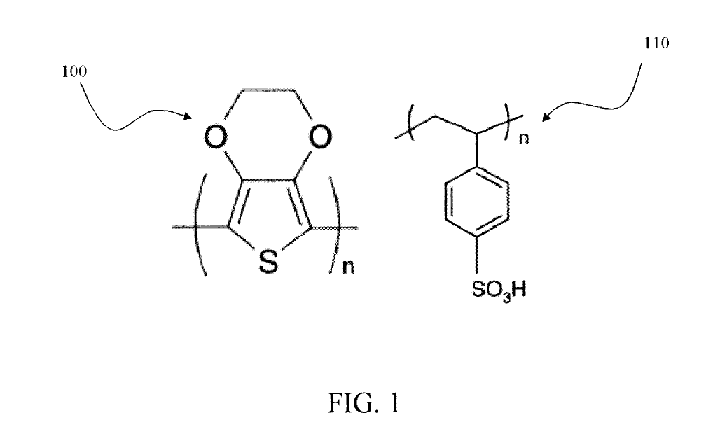

FIG. 1 is a schematic view of the chemical structure of PEDOT:PSS.

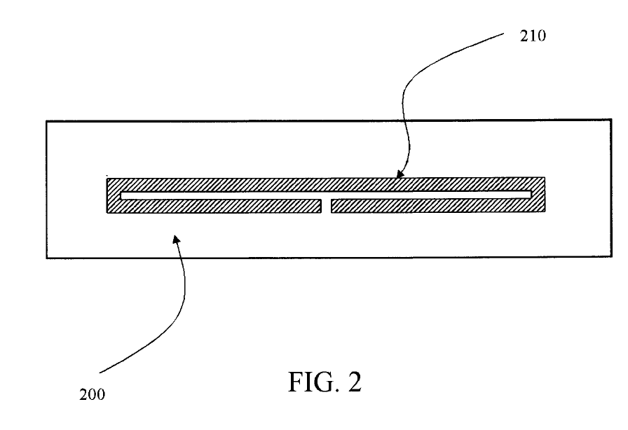

FIG. 2 is an exemplified schematic geometry of a folded dipole antenna according to the present invention.

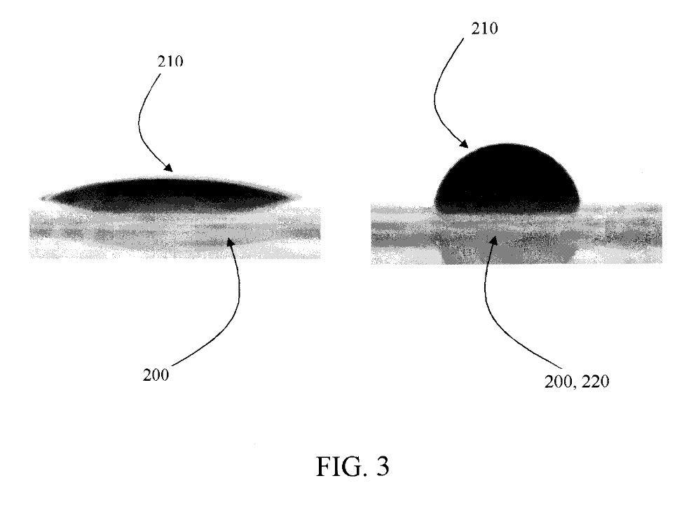

FIG. 3 is a photographic view of an exemplified contact angle measurement of PEDOT:PSS on a bare transparency (20±2° (Left) and on a toner layer (75±1°) (Right).

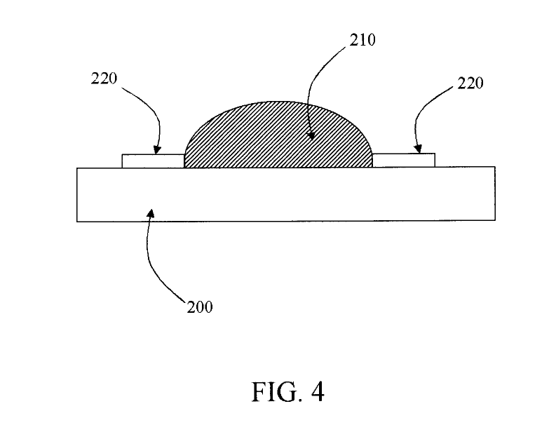

FIG. 4 is a schematic view of PEDOT:PSS on a PET substrate with a toner coating printed on the top surface.

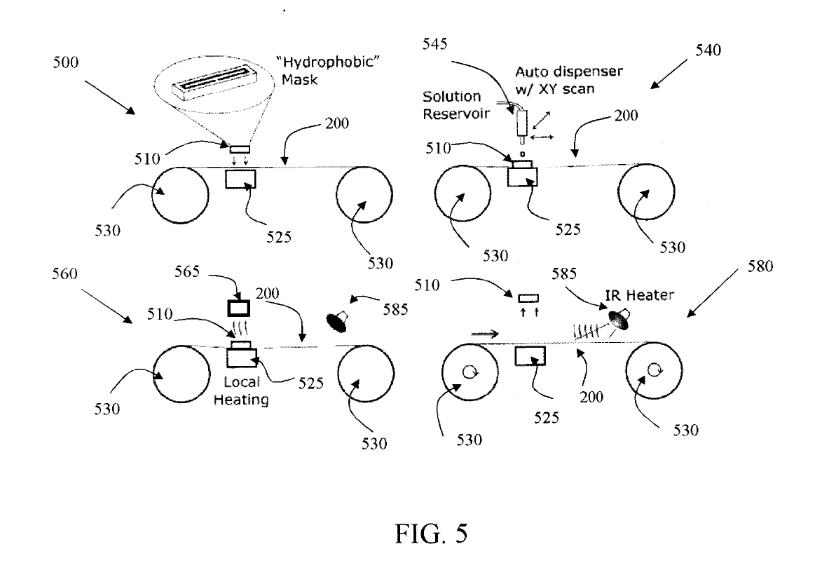

FIG. 5 is a schematic view of an exemplified roll-to-roll process for the drop-casting methodology that is assisted by the use of a hydrophobic mask.

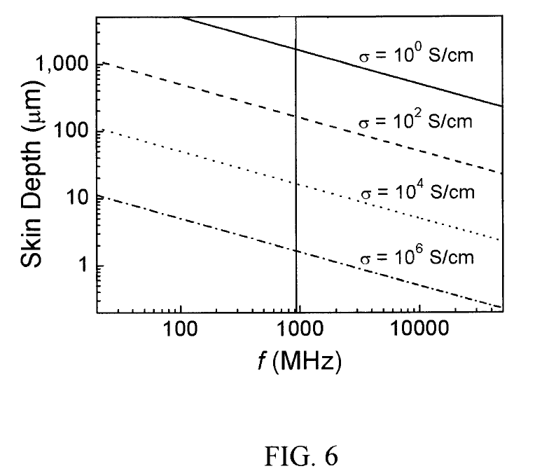

FIG. 6 is a graphical representation showing skin depths as a function of frequency f.

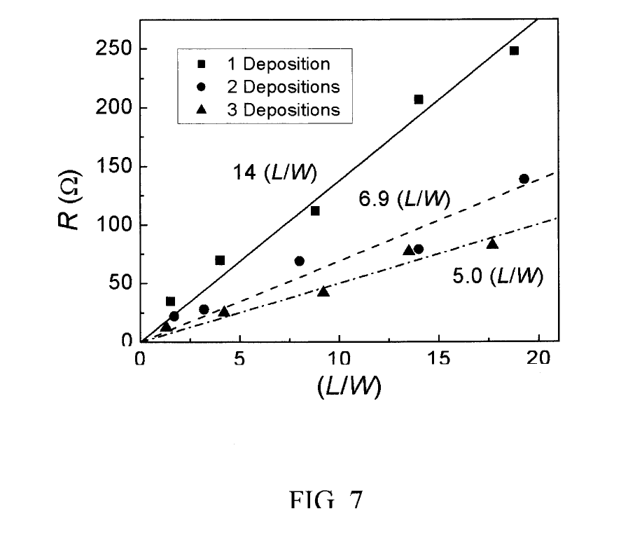

FIG. 7 is a graphical representation showing the resistance of strip lines fabricated using the toner-assisted drop-casting method as a function of (L/W).

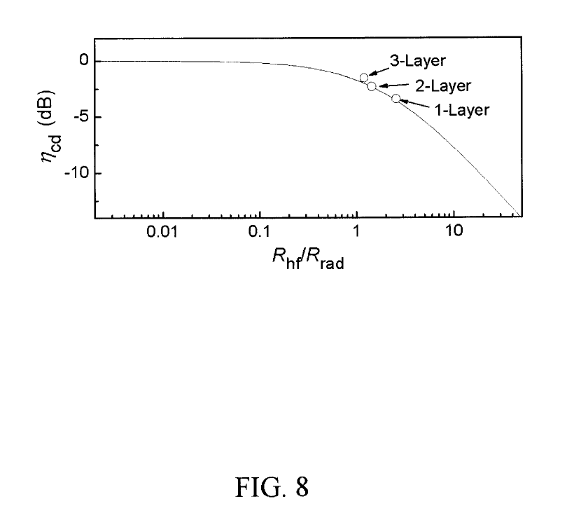

FIG. 8 is a graphical representation of the conduction-dielectric efficiency η_{cd} vs. (Rₗₒₛₛ/R_{rad}).

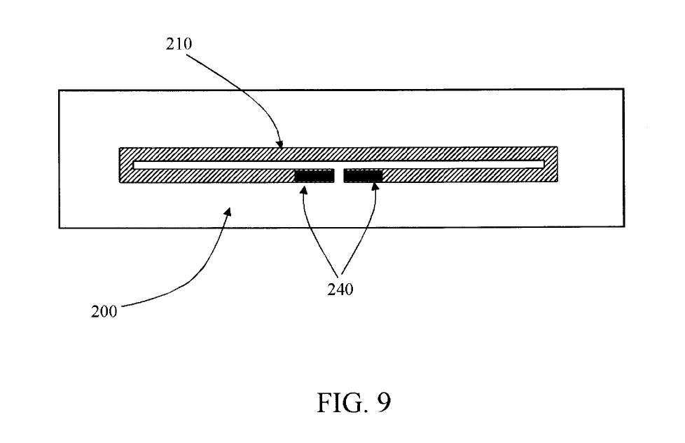

FIG. 9 is a schematic view of an exemplified fabricated PEDOT:PSS antenna according to the present invention.

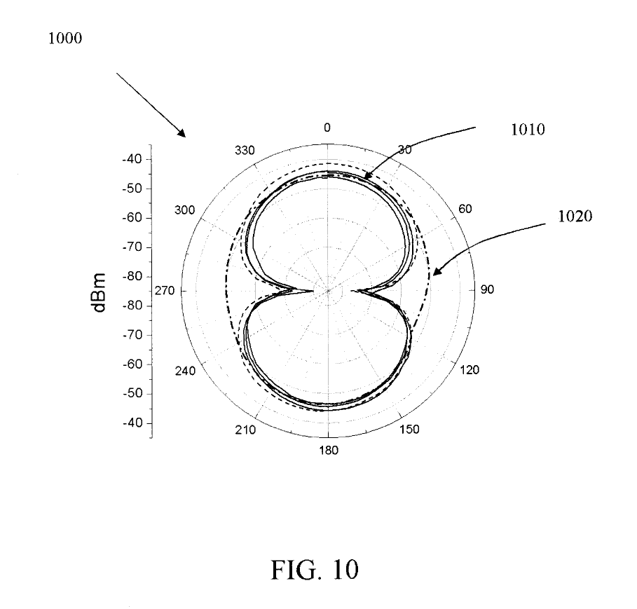

FIG. 10 is a graphical representation of the radiation patterns for antennas made of n layers of PEDOT:PSS (the solid lines, n=1, 2, 3 outward from the center).

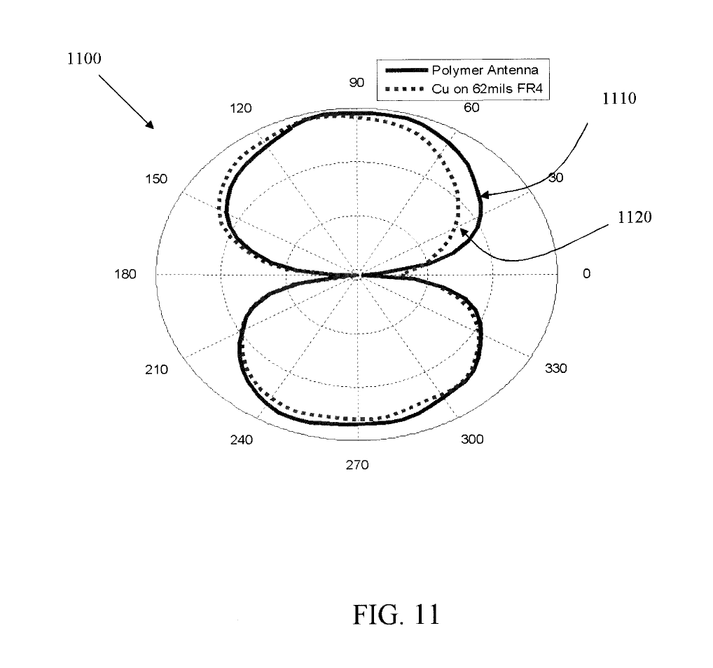

FIG. 11 is a graphical representation of the radiation patterns for antennas with a frequency of operation of about 2.45 GHz, showing a radiation pattern of a 2.45 GHz reference CU antenna fabricated on FR4.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a substrate” can include two or more such substrates unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The invention relates to an apparatus for receiving and transmitting electromagnetic signals. In one aspect, the apparatus is an antenna 10. However, it is contemplated that the apparatus may also comprise an RF isolator or other passive RF device. In another aspect, the apparatus is based on a common planar folded-dipole antenna, as seen in FIG. 2.

In one embodiment, the antenna 10 comprises a dielectric substrate 200 and a non-metallic conducting layer 210 substantially overlying the substrate 200. In one aspect, the non-metallic conducting layer 210 is an intrinsic conducting polymer (“ICP”). In one example, a high-conductivity formulation (Baytron F HC) of poly(3,4-ethylenedioxythiophene) doped with poly(4-styrenesulfonate), commonly referred to as PEDOT:PSS, may be used as the ICP. The chemical composition of PEDOT:PSS is shown in FIG. 1, where 100 is PEDOT and 110 is PSS. As one skilled in the art can appreciate, Baytron F HC is a high-conductivity version of water-based PEDOT:PSS (solid contents of approx. 2.2%) comprising a polyester dispersion to allow for better adhesion to plastic substrates. In yet another aspect, the ICP may comprise a doped polymer, such as, but not limited to, polyaniline, polypyrrole, polythiophene, or polyethylenedioxythiophene, and mixtures thereof. In another aspect, additives can be added to the ICP to increase its conductivity and stability.

In one exemplary aspect, the ICP has an electric conductivity greater than 10 S/cm. In another aspect, the ICP has an electric conductivity greater than 100 S/cm.

In one aspect, the exemplary antenna has a resonant frequency, or frequency of operation, greater than about 100 MHz. In another aspect, the frequency of operation is above 800 MHz. In one exemplary aspect, the antenna has a frequency of operation that is configured for about 915 MHz, which is one of the carrier frequencies for long-range (greater than about 1 m) commercial RFID tags. In yet another aspect, the frequency of operation is approximately 2.45 GHz.

In one exemplary method of manufacturing the antenna 10, the desired outline of the antenna may be first printed out on a substantially flexible substrate. In one example, transparencies (Office Depot, B & W copier transparencies #753-631, made from polyethylene terephthalate or PET) that are commonly used in laser printers or black- and white copiers may be used. However, other materials may be used for the substrate, including, but not limited to polyesters, polycarbonates, poly(methyl methacrylate)s, poly(styrene)s, polyolefins, polyimides, fluoropolymers, polysulfones, and the like. In one aspect, the substrate 200 has a thickness of between about 10 micrometers and 1 centimeter.

In this exemplary method of manufacturing, the area over which the ICP is deposited should preferably be left open, but surrounded with a line of hydrophobic material 220 that defines the desired shape. In one exemplary method, common laser printer toner may be used as the hydrophobic material 220. Then, the ICP solution is cast drop by drop over the substrate within the desired pattern using a syringe. As one skilled in the art will appreciate, any known methodology of dropping the ICP onto the substrate will suffice. In this method, as mentioned above, PEDOT:PSS may be used as the ICP. As the PEDOT:PSS solution is water-based, and as one skilled in the art will appreciate, the “hydrophobic wall” formed by the toner outline confines the PEDOT:PSS solution within the desired area, which realizes an easy and efficient methodology of patterning. In another exemplary aspect, and as shown in FIG. 3, the contact angle of PEDOT:PSS droplet on a toner layer is about 75°, which is not as large as that of water (about 97°), but exhibits a sufficient contrast to the low contact angle of PEDOT:PSS droplets on a bare transparency film (about 20°).

In a further aspect, the described toner-assisted drop-casting method not only easily makes desired patterns but also enables the deposition of thick layers by allowing relatively large quantity of solution to be confined without overflooding. Once the pattern is filled with ICP solution, it is preferable to dry the ICP. In one aspect, the whole sample may be soft-baked with a hot air gun (at about 140° C. for about 5 minutes, with the hot air gun positioned approximately 2 inches away from the surface) for easy handling. Optionally, a substrate could be heated directly from an underlying hot plate. It is recommended, in this aspect, that the substrate 200 is to be held flat and stable on the hot plate. In this aspect, a moderate temperature in the range of between about 60 to about 80° C. is typically used to soft-bake the sample. After the soft-baking procedure, the substrate and ICP may be further dried in vacuum oven. In one example, the oven is set to a temperature at about 80° C. for at least 30 min. In another aspect, it is contemplated that the toner layer can be selectively removed later by application of a gentle stream of toluene or other solvent.

Another exemplary approach using laser printer or copier toner to pattern PEDOT:PSS films may also be employed in a combination with bar-coating techniques in which the toner serves also as a spacer to control the wet thickness of PEDOT:PSS. Similarly, an ultra-narrow line of hydrophobic polyimide layer may be used to define a short channel between source and drain electrodes made of PEDOT:PSS in OFETs using inkjet or screen printing techniques.

As one skilled in the art can appreciate, the efficiency of an antenna is directly proportional to conduction-dielectric efficiency η_{cd} defined by Equation 1:

$${η}_{c d} ≡ \frac{1}{1 + {R}_{loss} / {R}_{ra d}}$$

in which R_{rad} is the radiation resistance and Rₗₒₛₛ is the resistance that accounts for conduction-dielectric loss. In one aspect, R_{rad} depends on antenna configurations and is estimated to be 232Ω for an antenna with folded dipole geometry. From the noted equation 1, one skilled in the art can conclude that it is preferred to maintain high conductance at an operating frequency f so that Rₗₒₛₛ is significantly smaller that R_{rad}. FIG. 6 shows the skin depths δ(f) of materials with some representative values of conductivity σ as a function of frequency f. FIG. 6 shows skin depths δ calculated using δ=(πfσμ₀)^{-1/2} for materials with a conductivity σ of 10^{2p} S/cm (p=0, 1, 2, and 3) as a function of frequency f. As used in FIG. 6, μ₀ to is the magnetic permeability of free space and the materials are assumed non-magnetic. When one considers a typical range of conductivity to be 1 S/cm to several hundreds S/cm for conducting polymers, it is expected that the even approximately 50-μm thick conducting polymer films are still within a skin depth at f of up to several GHz. Therefore, it was unexpectedly found that deposition of relatively thick conducting layers can be an effective way to improve the efficiency of CP-based antennas virtually in any practical frequency range. In one aspect, the ICP comprises a thickness smaller than its skin depth at a given frequency of operation. In another aspect, the thickness is also larger than one tenth ( 1/10) of the skin depth of the ICP at the frequency of operation.

In one experiment, 10 mm-thick solid films were obtained in a single deposition. FIG. 7 shows the measured resistances of the CP lines prepared on transparencies by the described method as a function of length (L)-to-width (W) ratios. In one example, L varied and W was fixed at about 0.5 cm. A PEDOT:PSS solution of 46±10 μL/cm² was used on average. From the slope of the linear fit to the experimental data shown in FIG. 7, a sheet resistance is estimated to be 14±2 Ω/sq. for single-layer samples with an average thickness of about 10±2 μm. This is translated as a conductivity σ of 70±20 S/cm.¹⁵ In another aspect, sheet conductance (=1/Rs) is in a near-linear fashion upon an additional deposition of PEDOT:PSS after drying. Films with multiple layers can exhibit local variation in thickness.

Referring now to FIG. 9, a representation of a CP antenna made of n-layers of PEDOT:PSS is shown. In this example, a double layer antenna is shown. While it is contemplated that the CP antenna may comprise at least one layer PEDOT:PSS, preferably the CP antenna may have a plurality of layers. In one example, the solution used for each antenna was approximately 0.8 mL per deposition, that is, 50 μL/cm² per deposition. DC port-to-port resistance R_{de} of the CP antenna was 597Ω, 336Ω, and 279Ω, respectively for n=1, 2, and 3. FIG. 9 also shows the use of conducting pads 240 to improve electrical contacts.

The polar plot shown in FIG. 10 shows the effect of multiple layers of ICP on the resulting antenna. Graphically, 1000 represents radiation patterns of 915 MHz antennas made with n layers of PEDOT:PSS; 1010 represents radiation patterns of 915 MHz antennas with n=1, 2, 3 layers of conducting polymer from the center outward; and 1020 represents radiation patterns (dash dot) measured when the 3-layer PEDOT:PSS antenna was folded to form a circle.

The polar plot shown in FIG. 11 summarizes the performance of those exemplary antennas in comparison to that of the reference antenna made of copper on a standard FR-4 substrate. Graphically, 1100 represents radiation patterns for 2.45 GHz antennas; 1110 represents radiation patterns of a 2.45 GHz antenna fabricated from PEDOT:PSS on a PET substrate; and 1120 represents radiation patterns (dotted line) of a 2.45 GHz reference Cu antenna fabricated on a standard FR-4 substrate. It can be easily seen that all three antennas exhibit the standard dipole radiation patterns with a relatively good symmetry. Relative differences of signal strength measured from the CP antenna with respect to that measured from the Cu-reference antenna were −3.4 dB, −2.3 dB, and −1.6 dB, respectively for CP antennas having n=1, 2, and 3 layers of PEDOT:PSS when averaged over all the azimuthal angles. The performance of the 3-layer CP antenna with its shape made round by attaching the one end of the substrate to the other end was measured. As can be observed in the dash-dot curve of FIG. 10, the antenna unexpectedly exhibited an omni-directional radiation pattern, demonstrating the additional capability of the flexible antenna.

In Equation 1, Rₗₒₛₛ can be conveniently approximated to Rₗₒₛₛ=0.5 R_{hf} for a half-wave dipole antenna in which R_{hf} is the high-frequency resistance that accounts for the skin effect. For an antenna in a flat geometry, R_{hf} is given by Equation 2:

$${R}_{hf} \approx \{ \begin{matrix}{R}_{d c} = {R}_{S , d c} ( l / W ) , & if δ \geq d \\ {R}_{S , d c} ( d / δ ) ( l / W ) , & otherwise\end{matrix}$$

in which R_{dc} is the dc port-to-port resistance, R_{S,dc}=(σd)⁻¹ the dc sheet resistance, and d, l and W are the thickness, length and width of the conducting trace of a given antenna, respectively. As can be seen in FIG. 8, the observed reductions of the signal strength with respect to the reference Cu-antenna substantially follows the trend of η_{cd} given by Equation 1 with Rₗₒₛₛ=0.5 R_{hf}=0.5 R_{dc}. The results are surprising, as they indicate that conducting polymers can be treated in substantially the same way as regular metallic conductors for f up to 915 MHz.

The method described in the previous example is very useful for low-cost quick prototyping and thus can reduce a great amount of time and initial cost when developing or testing a new device structure.

In an alternative method embodiment, a mask defining an opening of a desired structure is prepared. This mask can be made of hydrophobic material or, optionally, the edge of the opening can coated with hydrophobic material. In one aspect, the hydrophobic materials to be used are to have a good thermal stability or at least should withstand temperatures in the range of between about 60 to about 80° C. When used directly (rather than as a coating), in this aspect, the selected hydrophobic materials should possess a good mechanical strength to maintain a desired structure without deformation. In one example, and not meant to be limiting, polytetrafluoroethylene is known to be hydrophobic and has good thermal stability and mechanical strength. The suitable thickness of a mask can vary depending on the application, but it is contemplated that a thickness in the range of at least one mm to about 10 mm should suffice in most cases. It is also contemplated that the mask can have a thickness greater than 10 mm.

Subsequently, in this aspect, the mask is lightly pressed against a substrate, and an aqueous solution of conducting polymer is dripped drop by drop or, optionally, dispensed in line within the open area. The quantity of the aqueous solution can be increased (decreased) to allow for thicker (thinner) conducting traces. In one aspect, a soft or pliable substrate, such as a plastic, can be used so that the mask can have a good mechanical contact to ensure that the solution stays inside a desired pattern without leakage when the mask is pressed against the substrate.

In a further aspect, a conventional automatic liquid dispenser that is operably connected to a robotic translation arm can be used for automation of dispensing process. An example for such dispensing system is the I&J 6000 Gantry robot series and the DSP501A dispenser by I&J Fisnar, Inc (Fair Lawn, N.J.).

In an additional aspect of the alternative methodology embodiment, the patterned area on which conducting polymer solution is drop-cast is locally heated at between about 60 to about 80° C. in order to soft bake the solution. In this exemplary aspect, the patterned area is locally heated for at least one minute. For the local heating, the supporting block can comprise a means for supplying the desired a heating capability.

In a further aspect, a means for supplying a cooling capability would also be provided. The means for supplying a cooling capability can be used to ensure a substrate temperature is substantially the same as the surrounding the room temperature throughout the dispensing of the aqueous solution so that the liquid can naturally flow within the desired pattern. This aids in forming uniform layers.

In another aspect, the mask is subsequently released from the substrate. Using a “hydrophobic mask” will ensure that the edges of conducting polymer layer stay intact without being stripped off during the release of the mask. The pattern can then be further heat-treated to result in fully solidified conducting polymer layer. The schematic shown in FIG. 5 depicts a possible arrangement of a roll-to-roll process suitable for this method. In this aspect, during step 500, the mask 510 is pressed against the substrate 200 that is placed above a solid block 525. The substrate is then placed on two rolls 530, that can be rotated between printing sequences. During step 540, a dispenser 545 drops the ICP solution into the mask 510. Then, during step 560, a heater 565 dries the ICP solution. Finally, in step 580, the mask is removed and the rolls are rotated to advance the substrate. An IR heater 585 may then be used to further dry the antenna that has been printed. For multiple layers, steps 500-580 may be repeated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

We claim:

1. An apparatus for receiving and transmitting electromagnetic signals comprising:
a dielectric substrate;
a non-metallic conducting layer substantially overlying the substrate, wherein the non-metallic conducting layer comprises an intrinsic conducting polymer.

2. The apparatus of claim 1, wherein the dielectric substrate is substantially flexible.

3. The apparatus of claim 2, wherein the substrate comprises a material selected from the group consisting of polyesters, polycarbonates, poly(methyl methacrylate)s, poly(styrene)s, polyolefins, polyimides, fluoropolymers, and polysulfones.

4. The apparatus of claim 2, wherein the substrate comprises polyethylene terephthalate.

5. The apparatus of claim 2, wherein the substrate has a thickness of about between 10 micrometers and 1 centimeter.

6. The apparatus of claim 1, wherein the intrinsic conducting polymer comprises a doped polymer selected from the group consisting of polyaniline, polypyrrole, and polythiophene.

7. The apparatus of claim 1, wherein the intrinsic conducting polymer comprises PEDOT-PSS.

8. The apparatus of claim 1, wherein the apparatus is an RF antenna.

9. The apparatus of claim 8, wherein the apparatus is a folded dipole RF antenna.

10. The apparatus of claim 1, wherein the intrinsic conducting polymer has an electric conductivity greater than 10 S/cm.

11. The apparatus of claim 1, wherein the intrinsic conducting polymer has an electric conductivity greater than 100 S/cm.

12. The apparatus of claim 1, wherein the intrinsic conducting polymer comprises a skin depth that correlates to the frequency of the electromagnetic signals, and wherein the non-metallic conducting layer comprises a thickness smaller than the skin depth of the intrinsic conducting polymer at a given frequency of operation and larger than one tenth ( 1/10) of the skin depth of the intrinsic conducting polymer at the frequency of operation.

13. The apparatus of claim 12, wherein the frequency of operation is greater than 100 MHz.

14. The apparatus of claim 12, wherein the frequency of operation is greater than 800 MHz.

15. The apparatus of claim 12, wherein the frequency of operation is approximately 915 MHz.

16. The apparatus of claim 12, wherein the frequency of operation is approximately 2.45 GHz.

17. A method of manufacturing an apparatus for receiving and transmitting electromagnetic signals, comprising the steps:
providing a dielectric substrate having a surface;
providing a hydrophobic liquid onto at least a portion of the surface of the dielectric substrate and forming a desired pattern therewith the hydrophobic liquid, wherein the pattern comprises a raised border;
applying an intrinsic conducting polymer in a substantially liquid form substantially within the border; and
drying the intrinsic conducting polymer.

18. The method of claim 17, wherein the step of drying comprises heating the intrinsic conducting polymer.

19. The method of claim 17, wherein the hydrophobic liquid comprises printing toner.

20. The method of claim 19, further comprising removing the hydrophobic liquid after the intrinsic conducting polymer is substantially dry.

21. The method of claim 20, wherein the step of removing the hydrophobic liquid comprises applying a quantity of solvent.

22. The method of claim 21, wherein the solvent is Toluene.

23. A method of manufacturing an apparatus for receiving and transmitting electromagnetic signals, comprising the steps:
providing a dielectric substrate having a surface;
applying an intrinsic conducting polymer onto at least a portion of the surface of the dielectric substrate using a printing process; and
drying the intrinsic conducting polymer.

24. The method of claim 23, wherein the printing process is an ink jet printing process.

25. The method of claim 23, wherein the printing process is a screen printing process.
